(19) United States
(12) Patent Application Publication
(10) Pub. No.: US 2012/0123889 A1
(43) Pub. Date: May 17, 2012

(54) SYSTEM AND METHOD FOR STREAMLINED ACQUISITION, DOWNLOAD AND OPENING OF DIGITAL CONTENT

(76) Inventor: LUIS D. MOSQUERA, Foster City, CA (US)

(21) Appl. No.: 13/271,131

(22) Filed: Oct. 11, 2011

Related U.S. Application Data
(60) Provisional application No. 61/406,867, filed on Oct. 26, 2010.

(51) Int. Cl. G06Q 30/06; G06F 15/16

(52) U.S. Cl. 705/26.1; 709/219

(57) ABSTRACT

A system and method for the purchase, downloading and opening of digital content, which is accomplished with one or two gestures, e.g., button or taps. Digital content items are displayed on the user's local device along with a button, i.e., a “Buy” button that can be selected to purchase a particular item of content. The user taps, clicks, or selects the “Buy” button to initiate the purchase, downloading and opening of the content. The instruction to purchase the content is transmitted to the remote server, which completes the purchase transaction and begins the download of the purchased content. Included with the downloaded content, preferably as parameters or metadata, is an indication of which reader application is required to open and read the digital content. When the download to the user's local device is completed, it uses these parameters to automatically launch the appropriate reader and automatically open the purchased, downloaded content, without any action required by the user.

### CROSS REFERENCE TO RELATED APPLICATION

This application claims benefit under 35 U.S.C. §119(e) from U.S. Provisional Patent application No. 61/406,867, filed on Oct. 26, 2010, the entirety of which is incorporated by reference herein.

### FIELD OF THE INVENTION

The present invention generally relates to electronic readers (e-readers), and more particularly to a system designed to allow a user to purchase, download, access, and open digital content, such as an electronic book, eBook, or an electronic periodical.

### BACKGROUND OF THE INVENTION

“Click-to-buy” user interfaces are well known and common in the field. Using existing technologies, a reader is typically required to first indicate a desire to purchase the eBook or digital periodical, enter credit information, confirm the purchase, download the book, navigate to the place where the book was downloaded (typically a library) and launch a reader application to access the eBook file. Only after performing these series of steps could the user open the digital content and start reading.

### SUMMARY OF THE INVENTION

The present invention provides a system that is faster, simpler, streamlined, intuitive and more convenient. In a preferred embodiment, the purchase, downloading and opening of digital content is ideally accomplished with a single gesture (button tap). In its preferred implementation, the current invention works in conjunction with appropriate operating systems (OSs), middleware, and application software necessary to support a touch-sensitive display and interaction sub-system (screen), complete with user interface, (UI), and facilities common to the art such as touch-sensitive buttons or tabs.

Generally speaking, the “touch/tap-to-read” sub-system is deployed throughout the broader UI on an as needed basis, and in its preferred implementation is instantiated and made manifest therein as a UI button labeled with “Tap to Read.”

Touch/tap-to-read buttons can occur at a multiplicity of points in the UI, in addition to appearing at the end of purchase processes. For example, if a user of an electronic reader thus equipped receives a recommendation of a book from a friend, the recommendation interface might include a touch/tap-to-read button. Similarly, if a reader accesses details about a book, including, for example, author, publication date, a brief synopsis, and other pertinent information, the interface displaying this data may be equipped with such a button.

A user can query a remote server that contains all of the digital content that can be downloaded (purchased). The digital content items that satisfy the query are displayed on the user's local device along with a button, a “Buy” button, that can be selected to purchase a particular item of content. Once the user finds the digital content that she wishes to purchase, she taps, clicks, or selects the “Buy” button to initiate the purchase, downloading and opening of the content. In some embodiments, the user is required to confirm the “Buy” gesture by tapping on a “Confirm” button. In either embodiment, the instruction to purchase the content is transmitted to the remote server, which completes the purchase transaction and begins the download of the purchased content. Included with the downloaded content, preferably as parameters or metadata, is an indication of which reader application is required to open and read the digital content. When the download to the user's local device is completed, it uses these parameters to automatically launch the appropriate reader and automatically open the purchased, downloaded content, without any action required by the user.

### BRIEF DESCRIPTION OF THE FIGURES

For the purposes of illustrating the present invention, there is shown in the drawings a form which is presently preferred, it being understood however, that the invention is not limited to the precise form shown by the drawing in which:

FIG. 1 illustrates a system according to the present invention;

FIG. 2 is a flowchart describing a method according to the present invention;

FIG. 3 is a flowchart describing an alternative method according to the present invention;

FIG. 4 depicts four states of the user interface sub-system;

FIGS. 5A-5D illustrate the user interface on a user's local device during a purchasing process;

FIGS. 6A-6C illustrate an embodiment requiring active input of a password;

FIGS. 7A-7D depict an embodiment of a purchase while reading digital content; and

FIGS. 8A and 8B are a flow chart illustrating a method according to the present invention.

### DETAILED DESCRIPTION OF THE INVENTION

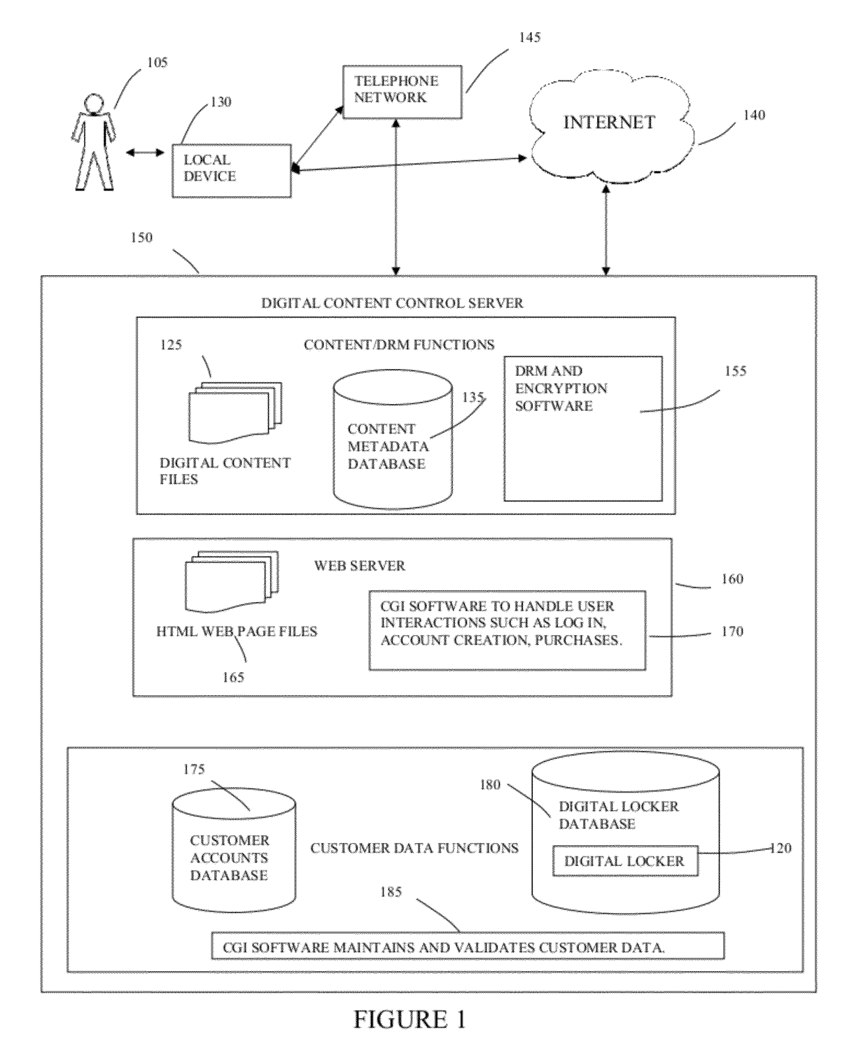

FIG. 1 shows components of digital content control system according to the present invention. User 105 is an authorized user of the digital content control system of the present invention. Many of the functions of digital content control system are carried out on digital content control server 150. As appreciated by those skilled in the art, many of the functions described herein can be divided between the digital content control server 150 and the user's local device 130. Further, as also appreciated by those skilled in the art, digital content control server 150 can be considered a “cloud” with respect to the user 105 and his local device 130. The cloud can actually be comprised of several servers performing interconnected and distributed functions. The user 105 can connect to the digital content control server 150 via the Internet 140, a telephone network 145 (e.g., a wireless cellphone network) or other suitable electronic communication channels. User 105 has an account on digital content control server 150, which authorizes user 105 to use the digital content control system.

Associated with the user's 105 account, is the user's 105 digital locker 120 located in a Digital Locker Database 180 on the digital content control server 150. As further described below, in the preferred embodiment, digital locker 120 contains links to copies of digital content 125 purchased (or otherwise legally acquired) by user 105.

Indicia of rights to all copies of digital content 125 owned by user 105 is stored by reference in digital locker 120. Digital locker 120 is a remote online repository that is uniquely associated with the user's 105 account. As appreciated by those skilled in the art, the actual copies of the digital content 125 purchased by user 105 are not necessarily stored in the user's locker 120, but rather the locker 120 stores an indication of the rights of the user to the particular content 125 and a link or other reference to the actual digital content 125. Typically, the actual copy of the digital content 125 is stored in another mass storage (not shown). The digital lockers 120 of all of the users 105 who have purchased a copy of a particular digital content 125 would point to this copy in mass storage. Of course, back up copies of all digital content 125 are maintained for disaster recovery purposes.

Although only one example of digital content 125 is illustrated in this Figure, it is appreciated that the digital content control server can contain millions of files 125 containing digital content. It is also contemplated that the digital content control server 150 can actually be comprised of several servers with access to a plurality of storage devices containing digital content 125. As further appreciated by those skilled in the art, in conventional licensing programs, the user does not own the actual copy of the digital content, but has a license to use it. Hereinafter, if reference is made to “owning” the digital content, it is understood what is meant is the license or right to use the content.

User 105 can access his or her digital locker 120 using a local device 130. Local device 130 is an electronic device such as a personal computer, an eBook reader, a smart phone or other electronic device that the user 105 can use to access the digital content control server 150. In a preferred embodiment, the local device 130 has been previously associated or registered with the user's 105 account using user's 105 account credentials. Local device 130 provides the capability for user 105 to download the user's copy of digital content 125 via his or her digital locker 120. After digital content 125 is downloaded to local device 130, user 105 can engage with the downloaded content locally, e.g., read the book, listen to the music or watch the video.

In a preferred embodiment, local device 130 includes a non-browser based user interface subsystem that allows user 105 to initiate the purchase of digital content 125 in a non-browser environment. Through the device interface, the user 105 is automatically connected to the digital content control server 150 in a non-browser based environment. This connection to the digital content control server is a secure interface and can be through the telephone network 145, typically a wireless cellular network for mobile devices. If user 105 is accessing his or her digital locker 120 using the Internet 140, local device 130 also includes a web account user interface subsystem. Web account interface provides user 105 with browser-based access to his or her account and digital locker 120 over the Internet 140. Web interface allows user 105 to initiate the purchase of digital content 125 in a browser based environment. Local device 130 further includes an input output subsystem that provides the interface between the local device 130 and the remote server 150. Local device 130 also includes an operating system that is operable to control the operations of the local device 130. For example, as further described below, the operating system is capable of examining downloaded content for parameters that indicate an application on the local device 130 that can be used to access the downloaded content, automatically launch the application without user command, and automatically open the downloaded content, again, without user action.

FIG. 1 further illustrates the detailed components of digital content control server 150. Digital content control server 150 handles front-end functions related to web server operations and user interactions with the web and device interfaces in connection with the user's local devices 130. Digital content control server 150 also handles all backend functions related to managing accounts, maintaining digital locker records, maintaining content metadata and providing encryption services.

Digital content control server 150 provides both the browser based web interface and the non browser based device interface. User 105 may engage with the web interface or the device interface to initiate a purchase.

Digital content control server 150 employs web server 160 including web services interface software 170 to handle interactions between front-end components, such as device interface, web account interface, and web interface, and back-end database components of the system. Web server 160 services include serving up the web pages 165 that comprise the web account interface and the web interface, and the underlying web services associated with the device interface. Web services interface software 170 include handling users' logins to their accounts and processing the initiation of and response to purchase requests.

Back-end database components of digital content control server 150 include customer accounts database 175, digital lockers database 180, and content metadata database 135. Records for users' accounts are stored and managed in customer accounts database 175. Records for digital lockers 120 are stored and managed in digital lockers database 180. Content metadata database 135 serves as a source of metadata for individual digital content items 125 in digital content control server 150.

Web services interface software 170 in the web server 160 interfaces with customer data services 185 to update customer accounts database 175 and digital lockers database 180. Customer data services 185 processes database updates such as maintaining and validating customer data in users' accounts. Web services interface software 170 in the web server 160 also interfaces with content encryption services 155 to secure certain communications with local device 130 and to package digital content 125 for secure delivery to user 105.

In the preferred embodiment of the invention, digital content control server 150 is an eBook and periodical digital content control system. Although the eBook and digital periodical applications are the preferred embodiment, as appreciated by those skilled in the art, the digital content control server 150 of the present invention is not limited to user 105 purchasing and using eBooks or digital publications. Digital content control server 150 can be used for purchase and use of any digital content, such as digital movies, digital music, digital audio books, digital pictures or other downloadable digital content.

In the preferred embodiment of the invention, local device 130 is a mobile electronic reader (eReader) device. The embodiment of the invention is not intended to limit local device 130 to a mobile eReader device. Local device 130 may be a desktop personal computer or another type of mobile consumer electronic device, such as, for example, a cell phone, a laptop computer, a tablet computer or other mobile digital device.

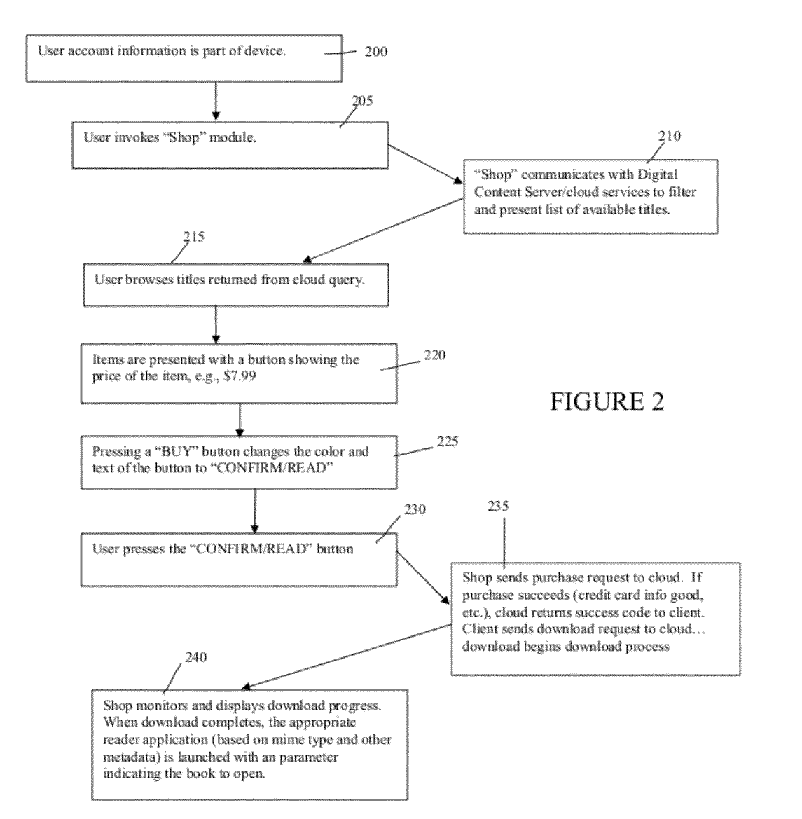

FIG. 2 illustrates a first embodiment of the present invention. As an initial step 200, the user's local device 130 has already been registered with the digital content control server 150 using the user's credentials. The registration process preferably includes providing a username, preferably the user's email address,and a password. The registration process further includes the user providing a method of payment for any purchases made on digital content control server 150, preferably a credit card. In step 205, a user 105 invokes a “Shop” application resident on local device 130 to shop for digital content 125 on the digital control server 150. The “Shop” application on the local device 130 connects the local device 130 to the digital content control server 150 through one of the communication channels described above (e.g., the Internet 140 or a telephone network 145). The “Shop” application, in conjunction the web server 160 in digital content control server 150, step 210, allows the user 105 to browse 215 and search the digital content 125 available on the digital content control server 150. As items of digital content 125 are presented to the user 105, they preferably include price of the item, step 220.

Once the user 105 finds some digital content 125 that she wishes to purchase on digital content control server 150, she taps/clicks on a “BUY” or similar button on the user interface on her local device 130, step 225. As shown below in connection with certain Figures that illustrate the UI for purchasing, the “Buy” button can be implemented on the screen of the local device 130 as the price of the item of digital content. In a preferred embodiment, the “BUY” button associated with the representation of the content 125 shown on the user's device 130 turns into a “CONFIRM/READ” button. In order to confirm the purchase, the user 105 taps/clicks the “CONFIRM/READ” button, step 230. Although not strictly necessary from a technical aspect, from a practical point of view, it is prudent for any online retailer to have the user confirm a purchase, in order to catch any inadvertent clicks by the user 105 on the “BUY” button. After the user taps/clicks the “CONFIRM” button, step 230, a request to purchase and download the selected digital content 125 is sent from the user's local device 130 to the digital control server 150.

In step 235, upon receipt of the purchase request, the server 150 performs the financial part of the transaction, e.g., credit card authorization. In a preferred embodiment, the server 150 already has the user's 105 credit card information in the user's account on the server 150 and no action is required by the user. Once the purchase has been financially authorized, the server 150 begins the download of the purchased digital content 125 to the user's local device 130. As described above, the content downloaded to the user's device 130 is encrypted and secured. As also described above, the server 150 also puts an indication of the ownership of the purchased content in the user's digital locker 120.

In step 240, once the download of the purchased digital content 125 to the user's local device 130 is complete, an appropriate reader application is automatically invoked. The operating system in device 130 knows which reader application to open based on the mime type and other metadata contained in the downloaded content 125. For example, one type of reader might be required to open a digital periodical, while another type of reader is required to open eBooks. Further, the launching of the appropriate reader application is accompanied by a parameter that indicates the specific digital content 125 to open, i.e., the just downloaded content 125. In this manner, the appropriate reader is automatically opened, the just purchased content 125 is automatically opened and the user 105 can immediately begin reading the content 125 without having to perform any further navigational actions or other actions on the local device 130.

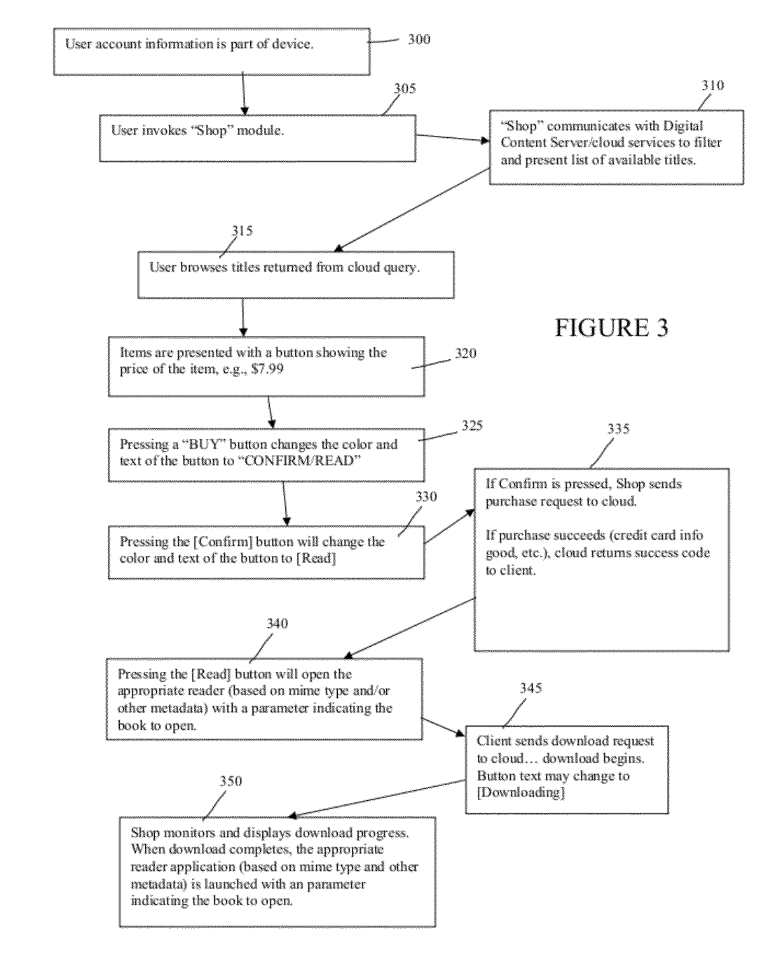

FIG. 3 illustrates an alternative embodiment of the present invention. Several of the steps in the method are similar to those described above with respect to the embodiment illustrated in FIG. 2. As an initial step 300, the user's local device 130 has already been registered with the digital content control server 150 using the user's credentials. In step 305, user 105 invokes a “Shop” application that is resident on her local device 130 to shop for digital content 125 on the digital control server 150. The “Shop” application on the local device 130 connects the local device 130 to the digital content control server 150 through one of the communication channels described above (e.g., the Internet 140 or a telephone network 145). The “Shop” application, in conjunction the web server 160 in digital content control server 150, step 310, allows the user 105 to browse 315 and search the digital content 125 available on the digital content control server 150. As items of digital content 125 are presented to the user 105, they preferable include price of the item, step 320, which can also act as the “Buy” button.

Once the user 105 finds some digital content 125 that she wishes to purchase on digital content control server 150, she taps/clicks on a “BUY” or similar button, which can be the price button on the user interface on her local device 130, step 325. In contrast with the embodiment illustrated in FIG. 2, in the embodiment shown in FIG. 3, when the user 105 selects the “BUY” button associated with the representation of the content 125 shown on the user's device 130, the “Buy”: button turns into a “CONFIRM” button (not a “CONFIRM/READ” button). After the user taps/clicks the “CONFIRM” button, step 330, a request to purchase and download the selected digital content 125 is sent from the user's local device 130 to the digital control server 150.

In step 335, upon receipt of the purchase request, the server 150 performs the financial part of the transaction, e.g., credit card authorization. In a preferred embodiment, the server 150 already has the user's 105 credit card information in the user's account and no action is required by the user. Once the purchase has been financially authorized, the server 150 begins the download of the purchased digital content 125 to the user's local device 130. As described above, the content downloaded to the user's device is encrypted and secured. As also described above, the server 150 also puts an indication of the ownership of the purchased content in the user's digital locker 120.

In step 340, once the download of the purchased digital content 125 to the user's local device 130 is complete, the process illustrated in FIG. 3 differs from the above described embodiment of FIG. 2. There is an extra act, step 340, where the “CONFIRM” button on the user's local device 105 turns into a “READ” button and the user must click this button in order to read the purchased content. The downloading of the content 125 can occur before or after the “READ” button is selected. FIG. 3 depicts the download occurring after “CONFIRM” is selected and before the “READ” button is presented and selected. Whether the user 105 wants to see this extra “READ” button can be customized in the user's system preferences. Some users would want to immediately read any content they purchase. Other users might want to the option of reading purchases immediately or at a later time. Further, the act of the user's selecting the “BUY” and “CONFIRM” buttons, in addition to the purchasing of the content 125, can also automatically trigger the downloading of the content. No further action by the user 105 is necessarily required to trigger the download. In step 345, the purchased content is downloaded and in step 350 the appropriate reader is automatically launched and the purchased content is automatically opened for reading.

The “BUY” button can appear on any number of screens on local device 130, whenever the user 105is viewing a representation of digital content 125 available for downloading purchase. It should be noted that although the preferred embodiment is described herein as involving a purchase of digital content 125, those skilled in the art appreciate that the same systems and methods apply equally to downloading free content. Irrespective of where in the UI a specific instance of a touch/tap-to-read button occurs, when a user taps the button, it triggers the same sequence of steps, or system behaviors, namely: (1) an order is placed with the provider of electronic digital books and periodicals; (2) user account information, credit or debit, is accessed and processed by the provider for payment of the digital content; (3) the digital content, e.g., eBook, is downloaded to the user's device via a network, which includes servers and other hardware running appropriate database, communications, security, and other software sufficient to permit the secure transmission of digital electronic information over digital networks including wireless; and (4) the eBook is stored in an appropriate location on the user's local device, such as the on-device Library or “locker,” accessed automatically and opened on the current UI screen.

Although neither the details nor the locus of activity associated with each of these steps is communicated to the user via the UI, the activities triggered by the user activating the touch-to-read button happen only partly on the device. The preponderance of the activity occurs in the distributed computing/communications resources environment, e.g., server 150, “the cloud” to which the user's local device 130 is connected, most typically via a wireless network.

For example, the initial subset of such activity, i.e., placing the order and purchasing the digital content 125, includes accessing one or more data bases in server 150 as described above, as is typically maintained by providers of digital electronic books and periodicals. The acts in the server 150 include extracting previously stored user-specific data such as credit-card information. Provider-specific order tracking and delivery sub-systems, including appropriate additional databases adequate to complete the purchase are also engaged.

Once the purchase portion of the process is complete, appropriate cloud and device-based components of the system, e.g., the web server 160 in digital content control server 150, initiate a download of the purchased digital content 125. This download also includes appropriate flags, metadata or other triggers, which are captured by the user's local device 130. These flags, metadata or other triggers cause the user's local device to automatically execute the steps necessary to launch the appropriate reader application and automatically open the recently downloaded item for reading by the user 105.

As described above, although only a single touch is required in the preferred implementation, in some implementations, a second, confirmatory step may required by applicable law, since the purchase requires a transfer of finds. In such implementations, a payment confirmation step may also be required.

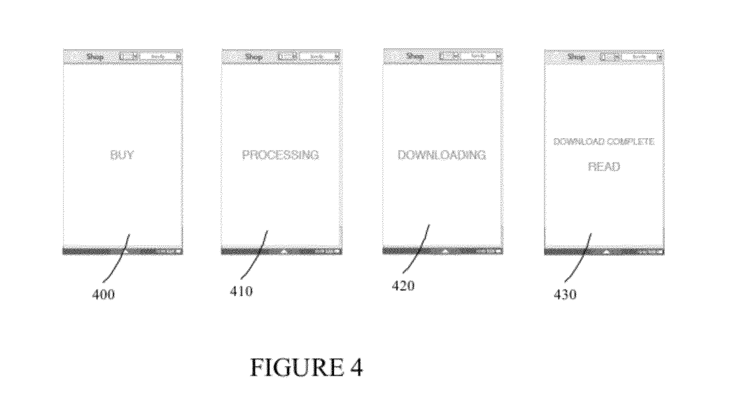

FIG. 4 depicts four states of the user interface screen on the user's local device 130 during an embodiment of the process of the present invention. An initial UI state 400 appears during the shopping phase of the process in which the “Touch/tap-to-Read” button as described above is presented to the user with the various item of digital content 125 available for purchase. This button could, for example, be included the details screen associated with a particular eBook or periodical of interest. A second UI state 410 is entered when the user taps the button to purchase the content 125. The UI displayed during this state preferably connotes that an order has been placed and is being processed. Note that this UI state description in connection with FIG. 4 does not detail all of the steps as described above in connection with the methods of FIGS. 2 and 3.

A third UI state 420 is entered when the financial portion of the process has been completed and a message is delivered to the user 105 to indicate that the digital eBook or periodical that she has just purchased is being downloaded to her local device 130. A fourth and final UI state 430 is then entered in which the user 105 is informed that the download is complete and the user is presented with the eBook or digital periodical opened in an appropriate reader application on the user's device 130.

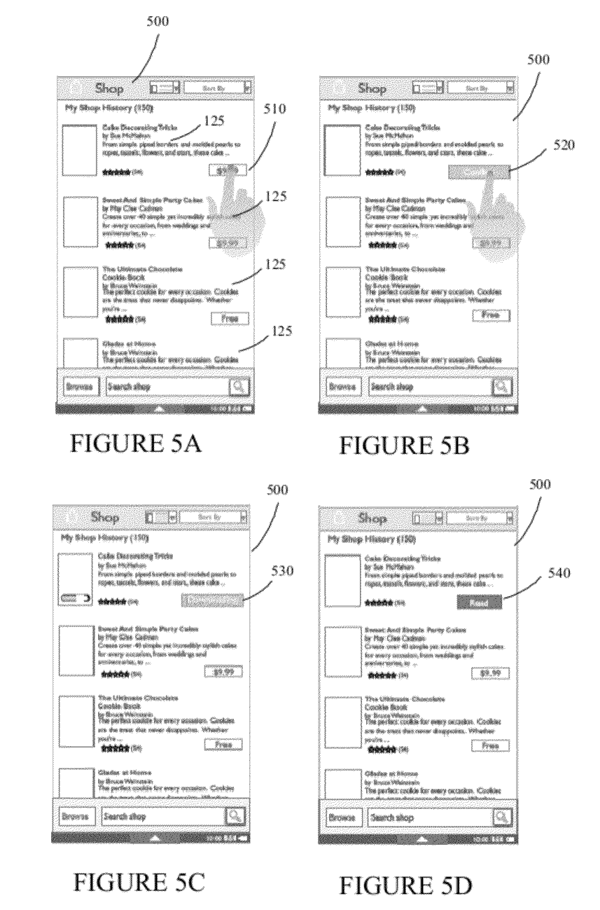

FIGS. 5A-5D illustrate the UI 500 on user's local device 130 during the process of one embodiment of the present invention. In FIG. 5A the user 105 is seen scrolling the results of a search query she performed on the digital content control server 150 for digital content 125. Several items of content 125 are shown displayed on UI 500. Associated with each of the items is the price 510 for the particular digital content 125. Note that some of the content 125 can be downloaded for free. If the user 105 wants to buy a particular title, she can activate, i.e., push, touch, tap, or click the button 510. In this embodiment, the price button 510 is also acting as a “BUY” button. As shown in FIG. 5B, if the user 105 selects the “Buy” button 510, it is converted to a “Confirm” button 520 in this embodiment that requires the user 105 to confirm her purchases.

If the user 105 hits the “Confirm” button 520, the back end processes in server 150 of completing the financial end the purchase are initiated. Once the purchase has been completed, the download of the purchased content 125 begins and the button 530 changes to show that the device 130 and the server 150 are downloading the purchased content. Once the download is complete, in the embodiment shown in these Figures, the button 540 changes to “Read” if the user would like to read the downloaded content 125 immediately. If she hits the “Read” button 540, the device automatically opens the reader appropriate for the downloaded content 125 and passes the reader parameters associated with the content 125 by which the reader application will automatically open the downloaded content 125 for reading.

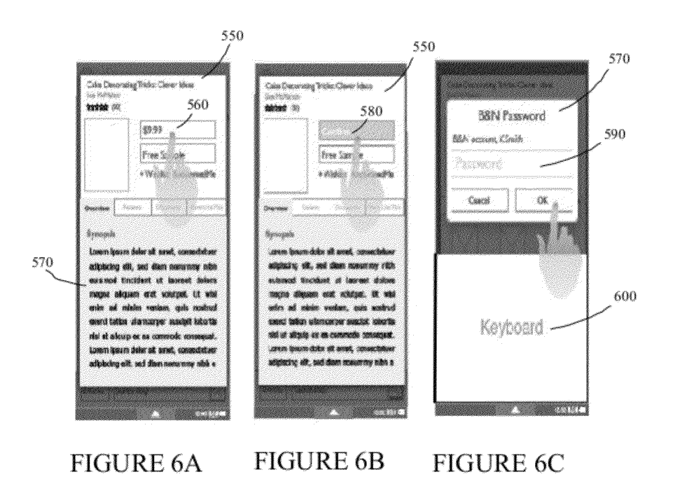

FIGS. 6A-6D illustrate an embodiment of the present invention where the digital content control server 150 requires a password before allowing the purchase of digital content. In the preferred embodiment, the digital content control server 150 already has the user's password stored with the user's account in Customer Account Database (see FIG. 1), and this password can be accessed once a secure connection is made between the user's device 130 and the digital content control server 150. However in the present embodiment, the system requires active input of the password by the user 105. In FIG. 6A, the user 105 is viewing a detail page 550 describing the details of a particular item of digital content 125. This detail page 550 includes a summary 570 of the item. As with previous embodiments, the page 550 includes a “Buy” button 560, which also shows the price of the item. When the user 105 clicks on the “Buy” button 560, it converts to a “Confirm” button 580 as illustrated in FIG. 6B. Selecting the “Confirm” button 580 causes a pop-up window 570 to be displayed as illustrated in FIG. 6C. This pop-up window 570 prompts the user 105 for her password 590, which can be typed in using the virtual keyboard 600. Once the password has been verified by the system, the process of completing the purchase transaction, downloading the purchased content, launching the appropriate reader and opening the purchased content for reading continues as describe above.

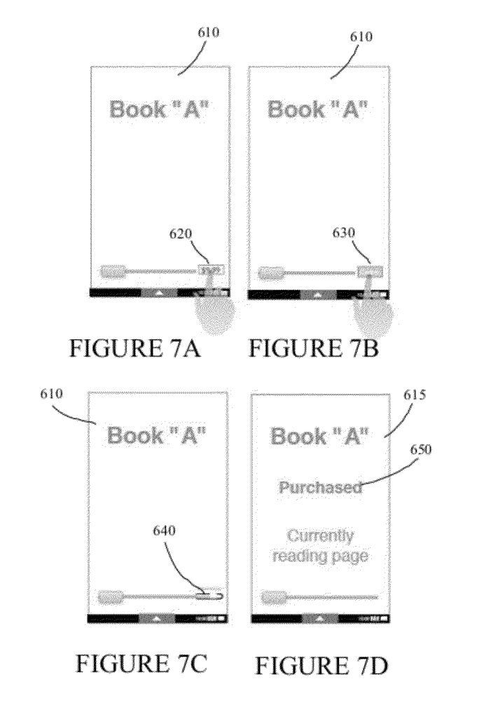

FIGS. 7A-7D illustrate an embodiment of the present invention in which a user 105 can purchase a copy of digital content while reading a sample. As illustrated in FIG. 7A, the user is currently reading a sample of a particular eBook 610. This is commonly done when visiting a retail location where books are sold. Retail locations often offer time or page limited access to their digital content while the user 105 is in the vicinity of the WiFi in the store. Users 105 can also download limited samples of eBook while at any location. On the sample 610 that the user is reading, a “Buy” button 620 is displayed. If the user 105 likes the sample that she is reading and would like to purchase a copy of the digital content, she can hit the button 620 to purchase a copy. As shown in FIG. 7B, the user is asked to confirm the purchase by hitting “Confirm” button 630. In FIG. 7C, the system indicates to the user via button 640 that the purchase has been successful and the purchased content is being downloaded. In FIG. 7D, the user receives a message that the purchase and download has been completed. However, unlike in the previous embodiments, the device 130 does not have to open the appropriate reader, as it is already open. Furthermore, when the download is completed, the already launched reader opens the purchased content 615 to the exact same page the user 105 was reading in the free sample 610. In this way, the purchase and download is relatively transparent to the user and she can just continue reading the content as if she were reading a purchased copy from the beginning.

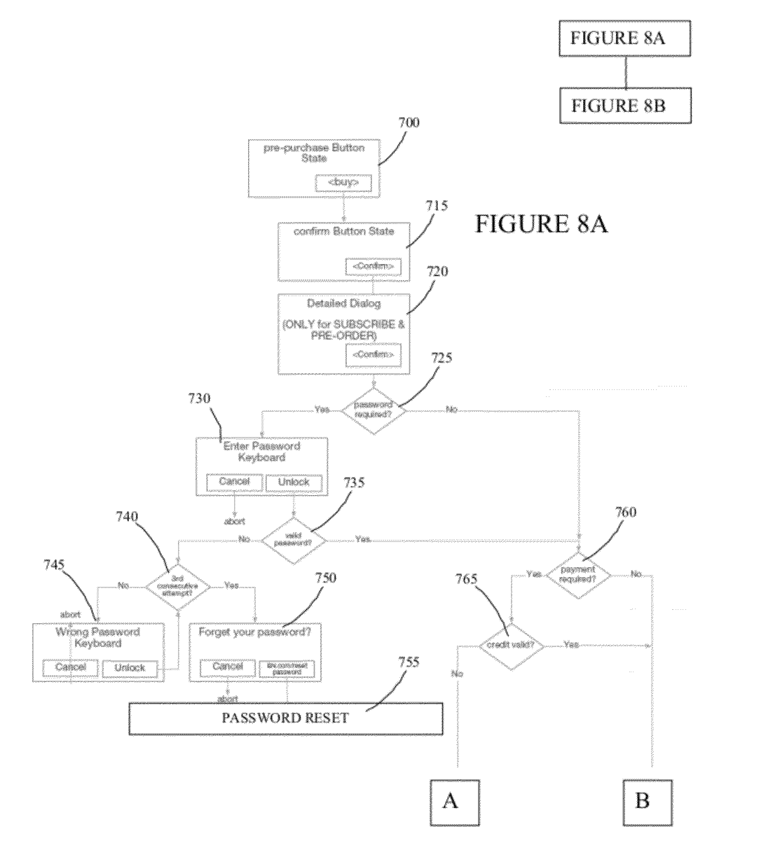

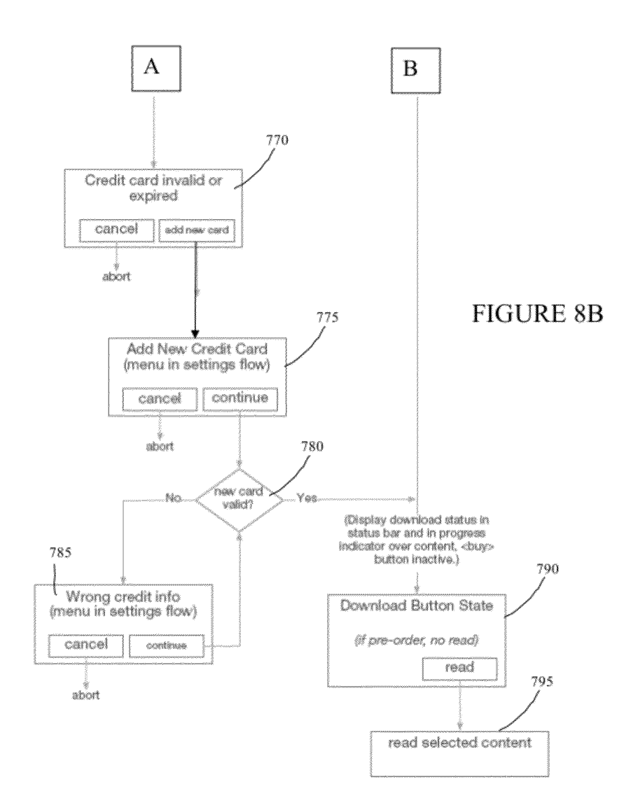

FIGS. 8A and 8B are a flow chart illustrating some of the methods of the present invention. The process starts at 700 with the “Buy” button in its initial state. For eBooks or other stand alone digital content, the button will typically be a “Buy” button. For digital periodicals, the user 105 can be presented with a “Current Issue” button for purchasing a single issue or a “Subscribe” button for purchasing a subscription to the digital periodical, e.g., a newspaper or a weekly magazine. The user 105 can also be presented with a “Pre-Order” button for digital content that has not yet been released. For free content, the button can be labeled “Get Free Content” or “Get Free Sample.”

When the user 105 selects the “Buy” button, or any of its variations described above, the confirm button is displayed 715, asking the user 105 to confirm the purchase. If the user 105 is purchasing a subscription or pre-ordering content that will be downloaded at a later time, an additional dialog box is displayed 720 explaining that there will be no immediate download. In step 725, it is determined if a password is required. If no password is required (e.g., user 105 has already been authenticated), it is determined, step 760, whether any payment is required. If no payment is required, the process continues at step B in FIG. 8B. If payment is required, the system determines, step 765, if the user's credit card is valid. If it is, the process continues at step B in FIG. 8B. If the user's credit card is not valid, the process continues at step A in FIG. 8B.

If a password is required, the user is prompted, 730, to enter her password. If the password is verified, step 735, the process continues at step 760 described above. If the password is incorrect, the user is given another try, step 745. If the correct password is entered, the process continues at step 760 as described above. On the third try, the user be asked, step 750, if she forgot her password, and is given the opportunity, step 755, to change the password.

Turning to A in FIG. 8B, if the user's credit card was determined to be invalid, e.g., a wrong number, cancelled or expired, the user 105 in steps 770-775 is given the opportunity to supply another credit card. In step 780, the validity of the new card is verified. If the new card is also determined to be invalid, the user is provided the opportunity to provide the correct credit card information, step 785. If the new credit is validated, the process continues along flow B.

In flow B, the financial aspects of the transaction have been completed. The user's device 130 displays a status that the download is in process while the server 150 is downloading the content to the device 130. After the download is complete, the system will either automatically launch the appropriate reader and open the book, or have the user confirm, step 790, by selecting a “Read” button that she wants to read the book. Once she clicks the “Read” button, the system automatically launches the appropriate reader and open the book. In step 795, the user can read the just purchased and downloaded content.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for acquiring and accessing digital content on a local device comprising:
receiving an indication from a user of the local device of an item of digital content to be acquired;
transmitting the indication of the item of digital content to a remote server;
receiving a download of the item of digital content from the remote server;
receiving parameters associated with the item of digital content indicating an application required to access the downloaded item of digital content;
automatically launching the application; and
automatically accessing the item of digital content using the launched application.

2. The method according to claim 1, wherein the digital content is an electronic book and the application is an electronic book reader.

3. The method according to claim 1, wherein the digital content is a digital periodical and the application is a digital periodical reader.

4. The method according to claim 1, further comprising:
receiving a query with respect to digital content from the user;
transmitting the query to the remote server;
receiving digital content data corresponding to digital content that satisfy the query; and
displaying the digital content data to the user.

5. The method according to claim 4, further comprising:
displaying a button associated the digital content data for each item of digital content data, the button enabling the user to provide the user's indication of the item of digital content to be acquired.

6. The method according to claim 1, wherein the indication from the user is a commitment from the user to purchase the item of digital content.

7. The method according to claim 6, further comprising:
receiving a confirmation from the user confirming the commitment to purchase the item of digital content.

8. The method according to claim 1, further comprising:
receiving a confirmation from the user confirming the indication to acquire the item of digital content.

9. The method according to claim 1, wherein parameters are contained in the downloaded item of digital content.

10. The method according to claim 1, wherein parameters are contained in metadata of the downloaded item of digital content.

11. The method according to claim 1, further comprising:
receiving a password from the user; and
transmitting the password to the remote server, the password enabling access to a user's account on the remote server.

12. A method for providing digital content to a local device comprising:
receiving an indication from the local device of an item of digital content to be acquired;
downloading the item of digital content to the local device;
downloading parameters associated with the item of digital content, the parameters indicating an application required to access the downloaded item of digital content, the parameters operable to enable the local device to automatically launch the application and automatically access the item of digital content using the launched application.

13. The method according to claim 12, wherein the digital content is an electronic book and the application is an electronic book reader.

14. The method according to claim 12, wherein the digital content is a digital periodical and the application is a digital periodical reader.

15. The method according to claim 14, further comprising:
receiving a query with respect to digital content from the local device;
determining digital content that satisfies the query; and
transmitting to the local device digital content data corresponding to digital content that satisfy the query.

16. The method according to claim 12, wherein the indication from the local device is a commitment from the user to purchase the item of digital content.

17. The method according to claim 16, further comprising:
verifying a credit card of the user; and
performing a financial transaction with the credit card of the user for the purchase of the item of digital content.

18. The method according to claim 16, further comprising:
receiving a confirmation from the local device confirming the commitment to purchase the item of digital content.

19. The method according to claim 12, wherein parameters are contained in the downloaded item of digital content.

20. The method according to claim 12, wherein parameters are contained in metadata of the downloaded item of digital content.

21. A device for acquiring and accessing digital content on a local device comprising:
a user interface subsystem operable to receive an indication from a user of the local device of an item of digital content to be acquired;
an input output subsystem operable to transmit the indication of the item of digital content to a remote server, receive a download of the item of digital content from the remote server, and receive parameters associated with the item of digital content indicating an application required to access the downloaded item of digital content; and
an operating system operable to automatically launch the application and automatically access the item of digital content using the launched application.

22. A system for providing digital content to a local device comprising:
a digital content database storing digital content available for downloading to the local device, the digital content database further storing parameters indicating an application required to access the digital content on the local device, the parameters operable to enable the local device to automatically launch the application and automatically access the digital content using the launched application; and
an interface server coupled to the digital content database, the interface server operable to:
receive an indication from the local device of an item of digital content to be acquired,
locate the item of digital content in the digital content database,
download the item of digital content to the local device, and
download to the local device the parameters associated with the item of digital content.
